(19) United States
(12) Patent Application Publication
(10) Pub. No.: US 2022/0398632 A1
(43) Pub. Date: Dec. 15, 2022

(54) PROVIDING GIFT SUGGESTIONS BASED ON PERSONALITY TRAIT INFORMATION

(71) Applicant: Verdicus Inc. DBA Diatom, Herriman, UT (US)

(72) Inventors: Richard Mahonri White, Salt Lake City, UT (US); Michael Law, Draper, UT (US); Christian Tooley, Chamblee, GA (US); Jonathan Law, Herriman, UT (US); Jon Dalton, Salt Lake City, UT (US); Dylan Reed Ferguson, Salt Lake City, UT (US); Burke Clark Powers, Orem, UT (US)

(21) Appl. No.: 17/836,878

(22) Filed: Jun. 9, 2022

Related U.S. Application Data
(60) Provisional application No. 63/208,678, filed on Jun. 9, 2021.

(51) Int. Cl. G06Q 30/02; G06F 16/335; G06F 16/248; H04L 67/306

(52) U.S. Cl. CPC G06Q 30/0269; G06F 16/335; G06F 16/248; H04L 67/306

(57) ABSTRACT

An apparatus for identifying a gift based on personality traits includes a user profile database with a plurality of user profiles. Each user profile includes user data correlated with personality trait information. The apparatus includes a product database with product entries of products. Each product entry includes personality trait information correlated to the product. The apparatus includes a gift request interface configured to receive from a first user a request to recommend a gift to a second user. The second user has a user profile in the user profile database. The apparatus includes a product correlation engine configured to correlate products from the product database with the second user based on the personality trait information of the user profile of the second user, and a gift presentation interface configured to display to the first user the one or more products from the product database correlated to the second user.

### CROSS-REFERENCES TO RELATED APPLICATIONS

This application claims the benefit of U.S. Provisional Patent Application No. 63/208,678 entitled “PROVIDING GIFT SUGGESTIONS BASED ON PERSONALITY TRAIT INFORMATION” and filed on Jun. 9, 2021 for Richard Mahonri White, et. al., which is incorporated herein by reference.

### FIELD

This invention relates to gift selection and more particularly relates to identifying a gift for a person based on personality trait information.

### BACKGROUND

Selecting a gift for a person can be difficult. Often a person selects a gift for another person that is not appreciated because the receiver of the gift has interests, hobbies, likes, etc. that do not align with the received gift.

### SUMMARY

An apparatus for identifying a gift for a person based on personality trait information includes a user profile database with a plurality of user profiles. Each user profile of a user includes user data of the user correlated with personality trait information of the user. The apparatus includes a product database with product entries of products. Each product entry includes personality trait information correlated to the product. The apparatus includes a gift request interface configured to receive from a first user a request to recommend a gift to a second user. The second user has a user profile in the user profile database. The apparatus includes a product correlation engine configured to correlate one or more products from the product database with the second user based on the personality trait information of the user profile of the second user, and a gift presentation interface configured to display to the first user the one or more products from the product database correlated to the second user. A method and computer program product also perform the functions of the apparatus.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic block diagram illustrating one embodiment of a system for gift suggestions;

FIG. 2 is a schematic block diagram illustrating one embodiment of elements of the system of FIG. 1 for gift suggestions;

FIG. 3 is a schematic block diagram/flowchart diagram illustrating one embodiment of elements of the system of FIG. 1 and method steps for gift suggestions;

FIG. 4 is a schematic block diagram illustrating one embodiment of an apparatus for gift suggestions;

FIG. 5 is a schematic block diagram illustrating another embodiment of an apparatus for gift suggestions;

FIG. 6 is a schematic block diagram illustrating one embodiment of an apparatus for product selection for a database for gift suggestions;

FIG. 7 is a schematic block diagram illustrating another embodiment of an apparatus for product selection for a database for gift suggestions;

FIG. 8 is a schematic block diagram illustrating one embodiment of an apparatus for correlating personality traits with products of a database for gift suggestions;

FIG. 9 is a schematic block diagram illustrating another embodiment of an apparatus for correlating personality traits with products of a database for gift suggestions;

FIG. 10 is a schematic flowchart diagram illustrating one embodiment of a method for gift suggestions;

FIG. 11 is a schematic flowchart diagram illustrating one embodiment of a method for product selection for a database for gift suggestions;

FIG. 12 is a schematic block diagram illustrating one embodiment of a method for updating personality traits with products of a database for gift suggestions;

FIG. 13A is a first part of a schematic block diagram illustrating another embodiment of a method for gift selections, for product selection for a database for gift suggestions, and for correlating personality traits with products of a database for gift suggestions; and

FIG. 13B is a second part of the schematic block diagram of FIG. 13A.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “engine,” “module,” “algorithm,” “system,” and the like. Furthermore, aspects of the present invention may take the form of a computer program product embodied in one or more computer readable medium(s) having program code embodied thereon.

Many of the functional units described in this specification have been labeled as engines, algorithms, analyzers, etc., in order to more particularly emphasize their implementation independence. For example, an engine, algorithm, analyzer, etc. may be implemented as a hardware circuit comprising custom VLSI circuits or gate arrays, off-the-shelf semiconductors such as logic chips, transistors, or other discrete components. An engine, algorithm, analyzer, etc. may also be implemented in programmable hardware devices such as field programmable gate arrays, programmable array logic, programmable logic devices or the like.

Engines, algorithms, analyzers, etc. may also be implemented in software with program code for execution by various types of processors. An identified engine, algorithm, analyzer, etc. of program code may, for instance, comprise one or more physical or logical blocks of computer instructions which may, for instance, be organized as an object, procedure, or function. Nevertheless, the executables of an identified engine, algorithm, analyzer, etc. need not be physically located together, but may comprise disparate instructions stored in different locations which, when joined logically together, comprise the module and achieve the stated purpose for the engine, algorithm, analyzer, etc.

Indeed, an engine, algorithm, analyzer, etc. of program code may be a single instruction, or many instructions, and may even be distributed over several different code segments, among different programs, and across several memory devices. Similarly, operational data may be identified and illustrated herein within engines, algorithms, analyzers, etc., and may be embodied in any suitable form and organized within any suitable type of data structure. The operational data may be collected as a single data set, or may be distributed over different locations including over different storage devices, and may exist, at least partially, merely as electronic signals on a system or network. Where an engine, algorithm, analyzer, etc. or portions of an engine, algorithm, analyzer, etc. are implemented in software, the program code may be stored and/or propagated on in one or more computer readable medium(s).

The computer readable medium may be a tangible, non-transitory computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (“RAM”), a read-only memory (“ROM”), an erasable programmable read-only memory (“EPROM” or “flash memory”), a portable compact disc read-only memory (“CD-ROM”), a digital versatile disc (DVD), an optical storage device, a magnetic storage device, a holographic storage medium, a micromechanical storage device, or any suitable combination of the foregoing. In the context of this document, a computer readable storage medium may be any tangible, non-transitory medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

Program code for carrying out operations for aspects of the present invention may be written in any combination of one or more programming languages, including an object-oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers. The computer program product may be integrated into a client, server and network environment by providing for the computer program product to coexist with applications, operating systems and network operating systems software and then installing the computer program product on the clients and servers in the environment where the computer program product will function.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent an engine, algorithm, analyzer, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for identifying a gift for a person based on personality trait information includes a user profile database with a plurality of user profiles. Each user profile of a user includes user data of the user correlated with personality trait information of the user. The apparatus includes a product database with product entries of products. Each product entry includes personality trait information correlated to the product. The apparatus includes a gift request interface configured to receive from a first user a request to recommend a gift to a second user. The second user has a user profile in the user profile database. The apparatus includes a product correlation engine configured to correlate one or more products from the product database with the second user based on the personality trait information of the user profile of the second user, and a gift presentation interface configured to display to the first user the one or more products from the product database correlated to the second user.

In some embodiments, the apparatus includes a personality profiler configured to receive information from a user and to analyze the information from the user to identify personality trait information of the user and configured to add the personality trait information of the user to a user profile of the user. In other embodiments, the information from the user includes answers to queries presented to the user. The queries and/or answers to the queries are configured to identify personality trait information of the user being presented the queries. In other embodiments, the personality trait information correlated to a product in the product database includes personality trait information of other users that have used the product.

In some embodiments, the apparatus includes a product analyzer configured to analyze product data of a product to be added to the product database to determine personality trait information associated with the product data, and a personality profiler configured to analyze information about users of the product to extract personality trait information from the information about the users of the product. In the embodiments, the product correlation engine is further configured to correlate the personality trait information of the users of the product with the product and/or to correlate personality trait information from the product data with the product, and the apparatus includes a product addition engine configured to insert product information of the product and associated personality trait information in an entry in the product database.

In other embodiments, the apparatus includes a product crawler configured to search websites for potential products to be added to the product database and to input the potential products to the product analyzer. In other embodiments, the apparatus includes a review crawler configured to find reviews of the product. The product analyzer uses the reviews to extract personality trait information about users of the product. In other embodiments, the apparatus includes a social media engine configured to locate social media information about the users of the product. The personality profiler extracts personality trait information of the users of the product from the social media information.

In some embodiments, each product entry of the product database includes a weighting factor for each personality trait of the personality trait information correlated to the product entry and the product correlation engine includes a machine learning algorithm configured to update the weighting factors based on personality trait information of users of the products in the product database and/or reviews from users of the product. In other embodiments, the apparatus includes a feedback engine configured to solicit a review from the second user after the second user has received a gift selected by the first user. The product correlation engine uses information from the review in correlating the selected gift with another user. In other embodiments, a user profile of the second user in the user profile database includes at least one event associated with the second user and the apparatus includes a gift message engine configured to send a message to the first user prior to the event. The message includes a reminder of the event of the second user and/or the display of the one or more products from the product database correlated to the second user.

In some embodiments, the apparatus includes a gift selection interface configured to receive a gift selection from the first user for purchase by the first user. The gift selection includes a product of the one or more products correlated to the second user. In some embodiments, the apparatus includes a gift purchase engine configured to send shipping instructions for a gift selected by the first user in response to the first user purchasing the selected gift.

A method for identifying a gift for a person based on personality trait information includes creating a user profile database with a plurality of user profiles. Each user profile of a user includes user data of the user correlated with personality trait information of the user. The method includes creating a product database with product entries of products. Each product entry includes personality trait information correlated to the product. The method includes receiving from a first user a request to recommend a gift to a second user. The second user has a user profile in the user profile database. The method includes correlating one or more products from the product database with the second user based on the personality trait information of the user profile of the second user and displaying to the first user the one or more products from the product database correlated to the second user.

In some embodiments, the method includes receiving information from a user and analyzing the information from the user to identify personality trait information of the user and adding the personality trait information of the user to a user profile of the user. In other embodiments, the personality trait information correlated to a product in the product database includes personality trait information of other users that have used the product. In other embodiments, the method includes analyzing product data of a product to be added to the product database to determine personality trait information associated with the product data and analyzing information about users of the product to extract personality trait information from the information about the users of the product. In the embodiments, correlating one or more products from the product database with the second user further includes correlating the personality trait information of the users of the product with the product and/or correlating personality trait information from the product data with the product, and the method includes inserting product information of the product and associated personality trait information in an entry in the product database.

In some embodiments, the method includes searching websites for potential products to be added to the product database and inputting the potential products for analyzing product data of a product to be added to the product database. In other embodiments, the method includes finding reviews of the product. Analyzing product data of a product to be added to the product database includes using the reviews to extract personality trait information about users of the product. In other embodiments, the method includes locating social media information about the users of the product. Analyzing information about users of the product to extract personality trait information includes extracting personality trait information of the users of the product from the social media information.

In some embodiments, each product entry of the product database includes a weighting factor for each personality trait of the personality trait information correlated to the product entry and correlating one or more products from the product database with the second user includes using a machine learning algorithm configured to update the weighting factors based on personality trait information of users of the products in the product database and/or reviews from users of the product. In other embodiments, the method includes soliciting a review from the second user after the second user has received a gift selected by the first user. Correlating one or more products from the product database with the second user includes using information from the review in correlating the selected gift with another user. In other embodiments, a user profile of the second user in the user profile database includes at least one event associated with the second user and the method includes sending a message to the first user prior to the event. The message includes a reminder of the event of the second user and/or the display of the one or more products from the product database correlated to the second user.

A program product for identifying a gift for a person based on personality trait information includes a non-transitory computer readable storage medium storing code. The code is configured to be executable by a processor to perform operations that include creating a user profile database with a plurality of user profiles. Each user profile of a user includes user data of the user correlated with personality trait information of the user. The operations include creating a product database with product entries of products. Each product entry includes personality trait information correlated to the product. The operations include receiving from a first user a request to recommend a gift to a second user, where the second user has a user profile in the user profile database, correlating one or more products from the product database with the second user based on the personality trait information of the user profile of the second user, and displaying to the first user the one or more products from the product database correlated to the second user.

An apparatus for correlating personality traits with products includes a product analyzer configured to analyze product data of a product to extract personality trait information associated with the product data, a personality profiler configured to analyze information about users of the product to extract personality traits from the information about the users of the product, a product correlation engine configured to correlate the personality trait information of the users of the product with the product and/or to correlate personality trait information from the product data with the product, and a product addition engine configured to insert product information of the product and associated personality trait information in an entry to a product database.

In some embodiments, the apparatus includes a product crawler configured to search websites for potential products to be added to the product database and to input the potential products to the product analyzer. In other embodiments, the apparatus includes a review crawler configured to find reviews of the product. The product analyzer uses the reviews to extract personality trait information about users of the product. In other embodiments, the apparatus includes a social media engine configured to locate social media information about the users of the product. The personality profiler extracts personality trait information of the users of the product from the social media information. In other embodiments, each product entry of the product database includes a weighting factor for each personality trait of the personality trait information correlated to the product entry and the apparatus includes a machine learning algorithm configured to update the weighting factors based on personality trait information of users of the products in the product database and/or reviews from users of the product.

In some embodiments, the apparatus includes a user profile database with a plurality of user profiles. Each user profile of a user includes user data of the user correlated with personality trait information of the user. In the embodiments, the apparatus includes a gift request interface configured to receive from a first user a request to recommend a gift to a second user, where the second user has a user profile in the user profile database. In the embodiments, the product correlation engine is further configured to correlate one or more products from the product database with the second user based on the personality trait information of the user profile of the second user. In the embodiments, the apparatus includes a gift presentation interface configured to display the one or more products from the product database and correlated to the second user. In further embodiments, the includes a feedback engine configured to solicit a review from the second user after the second user has received a gift selected by the first user. The product correlation engine uses information from the review in correlating the selected gift with another user.

In some embodiments, the product data includes information about the product from a webpage displaying the product for sale, from a manufacturer webpage of the product, and/or from a product review of the product. In other embodiments, the product analyzer and/or the personality profiler use a natural language processing engine to analyze product data of the product and to analyze information about users of the product.

A method for correlating personality traits with products includes analyzing product data of a product to extract personality trait information associated with the product data, analyzing information about users of the product to extract personality traits from the information about the users of the product, correlating the personality trait information of the users of the product with the product and/or to correlate personality trait information from the product data with the product, and inserting product information of the product and associated personality trait information in an entry to a product database.

In some embodiments, the method includes searching websites for potential products to be added to the product database and inputting the potential products for analyzing product data of a product to extract personality trait information associated with the product data. In other embodiments, the method includes finding reviews of the product. Analyzing product data of a product to extract personality trait information associated with the product data includes using the reviews to extract personality trait information about users of the product. In other embodiments, the method includes locating social media information about the users of the product. Extracting personality traits from the information about the users of the product includes extracting personality trait information of the users of the product from the social media information. In other embodiments, each product entry of the product database includes a weighting factor for each personality trait of the personality trait information correlated to the product entry and the method includes using a machine learning algorithm configured to update the weighting factors based on personality trait information of users of the products in the product database and/or reviews from users of the product.

In some embodiments, the method includes creating a user profile database with a plurality of user profiles. Each user profile of a user includes user data of the user correlated with personality trait information of the user and the method includes receiving from a first user a request to recommend a gift to a second user, where the second user has a user profile in the user profile database, correlating one or more products from the product database with the second user based on the personality trait information of the user profile of the second user, and displaying the one or more products from the product database and correlated to the second user. In other embodiments, the method includes soliciting a review from the second user after the second user has received a gift selected by the first user. Correlating the personality trait information of the users of the product with the product includes using information from the review in correlating the selected gift with another user.

In some embodiments, the product data includes information about the product from a webpage displaying the product for sale, from a manufacturer webpage of the product, and/or from a product review of the product. In other embodiments, the method includes using a natural language processing engine for analyzing product data of the product and for analyzing information about users of the product.

A program product for correlating personality traits with products includes a non-transitory computer readable storage medium storing code. The code is configured to be executable by a processor to perform operations that include analyzing product data of a product to extract personality trait information associated with the product data, analyzing information about users of the product to extract personality traits from the information about the users of the product, correlating the personality trait information of the users of the product with the product and/or to correlate personality trait information from the product data with the product, and inserting product information of the product and associated personality trait information in an entry to a product database.

In some embodiments, the operations include searching websites for potential products to be added to the product database and inputting the potential products for analyzing product data of a product to extract personality trait information associated with the product data. In other embodiments, the operations include finding reviews of the product, where analyzing product data of a product to extract personality trait information associated with the product data includes using the reviews to extract personality trait information about users of the product, and/or locating social media information about the users of the product. Extracting personality traits from the information about the users of the product includes extracting personality trait information of the users of the product from the social media information. In other embodiments, each product entry of the product database includes a weighting factor for each personality trait of the personality trait information correlated to the product entry and the operations include using a machine learning algorithm configured to update the weighting factors based on personality trait information of users of the products in the product database and/or reviews from users of the product.

An apparatus for correlating personality traits of users with products based on user reviews includes a user profile database with a plurality of user profiles. Each user profile of a user includes user data of the user correlated with personality trait information of the user. The apparatus includes a product database with product entries of products. Each product entry includes personality trait information correlated to the product. The apparatus includes a product display interface configured to present a product from the product database to a user with a user profile in the user profile database and receive a user review from the user, the user review comprising a positive review or a negative review of the product. The apparatus includes a product update engine configured to update personality trait information of an entry for the product in the product database based on the user review from the user.

In some embodiments, the personality trait information of entries of products in the product database include a weighting factor for each personality trait and the product update engine updates the weighting factors of the entry for the product in the product database based on the user review. In other embodiments, the product update engine includes a machine learning algorithm to update the weighting factors. Input to the machine learning algorithm includes user reviews from users with a user profile in the user profile database along with personality trait information from user profiles in the user profile database and/or user reviews from one or more websites along with personality trait information derived from webpages comprising information about the users providing the user reviews from the one or more websites. In other embodiments, the product update engine weights negative reviews more than positive reviews.

In some embodiments, the product update engine updates the personality trait information of the entry for the product by considering personality trait information of the user from a user profile of the user in the user profile database. In other embodiments, the product display interface includes a negative review interface configured to receive, from the user, reasons for the negative review of the product provided by the user and the product update engine is further configured to update the personality trait information of the entry for the product based on the reasons for the negative review received from the user. In other embodiments, the negative review interface is further configured to provide a list of reasons for a negative review by the user and to receive a selection of a reason on the list. The product update engine is further configured to update the personality trait information of the entry for the product based on the selected reason for the negative review received from the user.

In some embodiments, the apparatus includes a product correlation engine configured to correlate one or more products from the product database with the user based on the personality trait information of the user profile of the user. In other embodiments, the apparatus includes a product analyzer configured to analyze product data of a product to be added to the product database to determine personality trait information associated with the product data and a personality profiler configured to analyze information about users of the product to extract personality trait information from the information about the users of the product. The product correlation engine is further configured to correlate the personality trait information of the users of the product with the product and/or correlate personality trait information from the product data with the product. In other embodiments, the product display interface includes a swipe function. In response to the user swiping a first direction on a display of the product, the product display interface interprets the swipe in the first direction as a positive review of the product and in response to the user swiping a second direction on the display of the product, the product display interface interprets the swipe in the second direction as a negative review of the product. The first direction is opposite the second direction.

A method for correlating personality traits of users with products based on user reviews includes creating a user profile database with a plurality of user profiles. Each user profile of a user includes user data of the user correlated with personality trait information of the user. The method includes creating a product database with product entries of products. Each product entry includes personality trait information correlated to the product. The method includes presenting a product from the product database to a user with a user profile in the user profile database and receiving a user review from the user. The user review includes a positive review or a negative review of the product. The method includes updating personality trait information of an entry for the product in the product database based on the user review from the user.

In some embodiments, the personality trait information of entries of products in the product database include a weighting factor for each personality trait and the product update engine updates the weighting factors of the entry for the product in the product database based on the user review. In some embodiments, the product update engine includes a machine learning algorithm to update the weighting factors. Input to the machine learning algorithm includes user reviews from users with a user profile in the user profile database along with personality trait information from user profiles in the user profile database and/or user reviews from one or more websites along with personality trait information derived from webpages comprising information about the users providing the user reviews from the one or more websites. In some embodiments, the product update engine weights negative reviews more than positive reviews.

In some embodiments, the product update engine updates the personality trait information of the entry for the product by considering personality trait information of the user from a user profile of the user in the user profile database. In some embodiments, the method includes receiving, from the user, reasons for the negative review of the product provided by the user and the product update engine is further configured to update the personality trait information of the entry for the product based on the reasons for the negative review received from the user. In further embodiments, the negative review interface is further configured to provide a list of reasons for a negative review by the user and to receive a selection of a reason on the list. The product update engine is further configured to update the personality trait information of the entry for the product based on the selected reason for the negative review received from the user.

In some embodiments, the method includes correlating one or more products from the product database with the user based on the personality trait information of the user profile of the user. In other embodiments, the method includes analyzing product data of a product to be added to the product database to determine personality trait information associated with the product data and analyzing information about users of the product to extract personality trait information from the information about the users of the product. Correlating one or more products from the product database with the user based on the personality trait information of the user profile of the user includes correlating the personality trait information of the users of the product with the product and/or correlating personality trait information from the product data with the product.

A program product for correlating personality traits of users with products based on user reviews includes a non-transitory computer readable storage medium storing code. The code is configured to be executable by a processor to perform operations that include creating a user profile database with a plurality of user profiles. Each user profile of a user includes user data of the user correlated with personality trait information of the user. The operations include creating a product database with product entries of products. Each product entry includes personality trait information correlated to the product. The operations include presenting a product from the product database to a user with a user profile in the user profile database, receiving a user review from the user, where the user review includes a positive review or a negative review of the product, and updating personality trait information of an entry for the product in the product database based on the user review from the user.

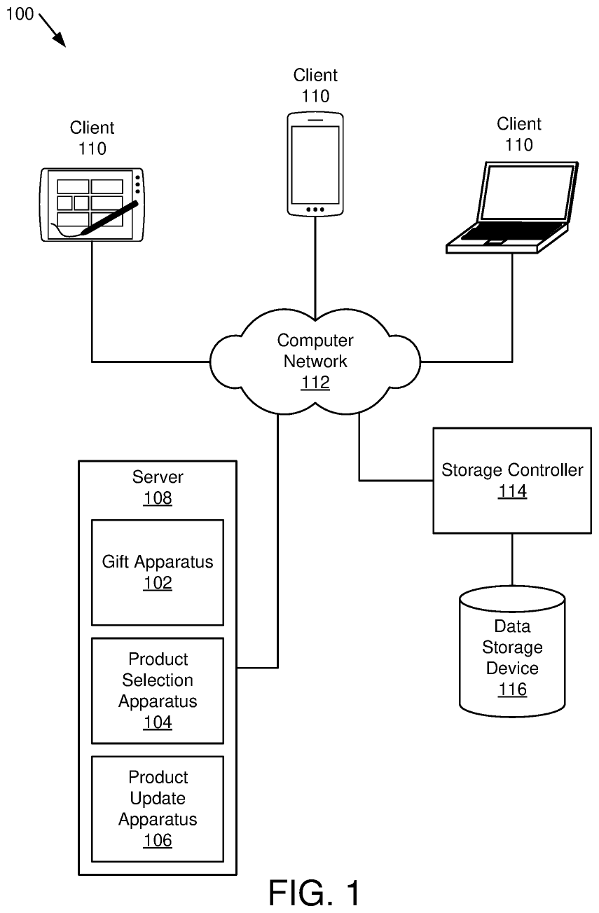

FIG. 1 is a schematic block diagram illustrating one embodiment of a system 100 for gift suggestions. The system 100 includes a gift apparatus 102, a product selection apparatus 104, and a product update apparatus 106 in a server 108, clients 110, a computer network 112, a storage controller 114 and a data storage device 116, which are described below.

The system 100 is representative of various systems where the embodiments described herein may be deployed. The server 108, in some embodiments, is in a data center and may be a cloud implementation. For example, the server 108 may be leased and the gift apparatus 102, the product selection apparatus 104, and the product update apparatus 106 may be implemented in one or more virtual machines, containers, or the like. In other embodiments, the server 108 is user-owned and the gift apparatus 102, the product selection apparatus 104, and the product update apparatus 106 are implemented thereon. While a single server 108 is depicted, one of skill in the art will recognize that the gift apparatus 102, the product selection apparatus 104, and the product update apparatus 106 may be deployed on multiple servers 108 for ease of deployment, for redundancy, etc.

The server 108 may be a rack-mounted server, a workstation, a mainframe computer, a desktop server, a laptop server, and the like or any combination thereof. The server 108 includes one or more processors, memory, data buses, access to non-volatile data storage, input/output connections, and the like. One of skill in the art will recognize other implementations of a server 108 capable of executing the gift apparatus 102, the product selection apparatus 104, and the product update apparatus 106.

The clients 110 are depicted as a tablet computer a smartphone, and a laptop computer as examples but may be implemented by a workstation, a desktop computer, a terminal, or other computing device capable of connection to the server 108 over the computer network 112. In some embodiments, a client 110 is used by a system administrator for installation, maintenance, control, etc. of the gift apparatus 102, the product selection apparatus 104, and the product update apparatus 106. In other embodiments, the clients 110 are user devices for using the gift apparatus 102, the product selection apparatus 104, and/or the product update apparatus 106. For example, a user may use a smartphone as a client 110 to interact with the gift apparatus 102, the product selection apparatus 104, and/or the product update apparatus 106.

The computer network 112 connects the clients 110 to the server 108 to access the gift apparatus 102, the product selection apparatus 104, and/or the product update apparatus 106 and may also be used to access the data storage device 116. The computer network 112 includes one or more networks. For example, the computer network 112 may include a LAN and may include a gateway to the Internet. The computer network 112 network may include cabling, optical fiber, etc. and may also include a wireless connection and may include a combination of network types. The computer network 112 may include a LAN, a WAN, a storage area network (“SAN”), an optical fiber network, etc. Various computer networks that are part of the depicted computer network 112 may be private and/or public, for example, through an Internet Service Provider.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA®”). Alternatively, the wireless connection may be a cellular telephone network communication. All standards and/or connection types include the latest version and revision of the standard and/or connection type as of the filing date of this application.

The system 100 is depicted with a storage controller 114 with a data storage device 116. In some embodiments, the storage controller 114 and the data storage device 116 are part of a SAN that is accessible to the server 108 and/or to the clients 110. Access to the data storage device 116 by client 110 may be indirect for typical users while a system administrator may have direct access to the data storage device 116 through the SAN or through the server 108. The data storage device 116 is depicted as a single data storage device but may include multiple devices. For example, the data storage device 116 may be accessed as one or more virtual storage devices and the data storage device 116 may be implemented with multiple data storage devices (e.g., computer readable storage media) deployed using a redundant array of independent devices (“RAID”) or the like. In other embodiments, the server 108 may include internal non-volatile data storage in addition to or in place of the data storage device 116 and storage controller 114. One of skill in the art will recognize other ways to implement non-volatile data storage, a server 108, etc. to implement the gift apparatus 102, the product selection apparatus 104, and the product update apparatus 106.

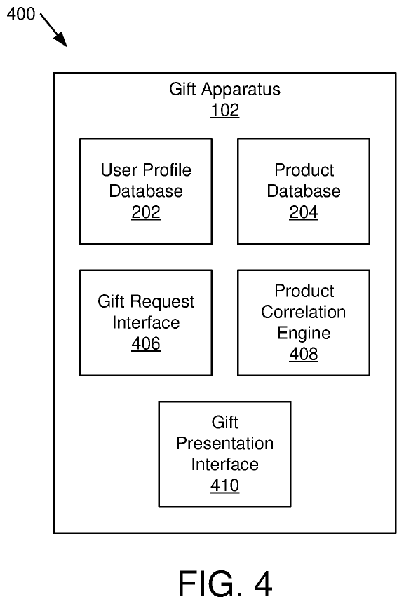

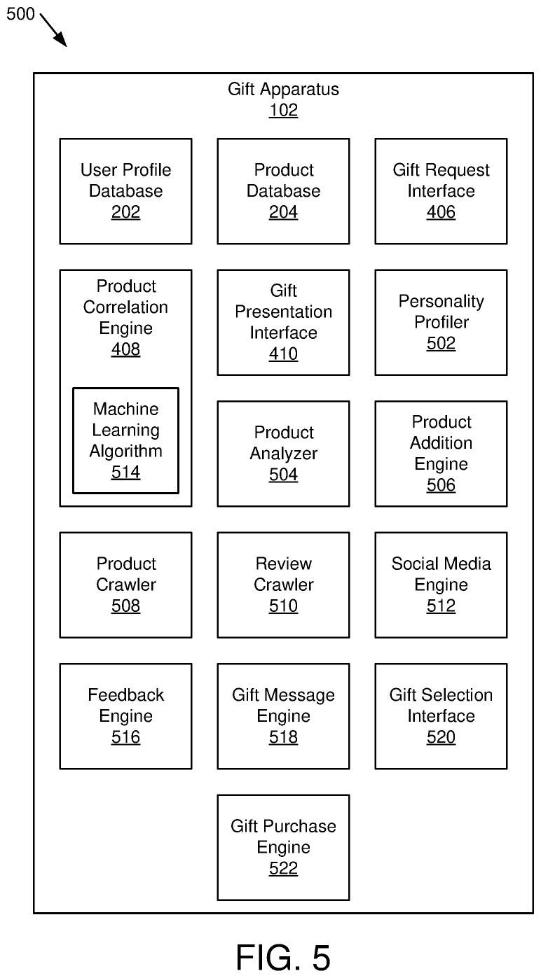

The gift apparatus 102 includes a user profile database, a product database and a way to correlate personality trait information of the users in the user profile database with products in the product database. The gift apparatus 102 receives a request from a first user to request to recommend gifts to a second user and then provides a display of one or more gifts that are correlated to personality traits of the second user to better assist the first user in selecting a gift for the second user that the second user will like. The gift apparatus 102 is described in more detail below in relation to FIGS. 4 and 5.

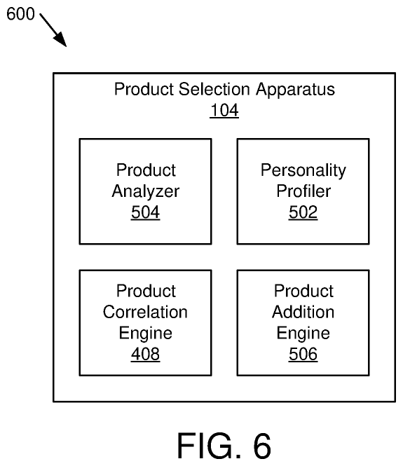

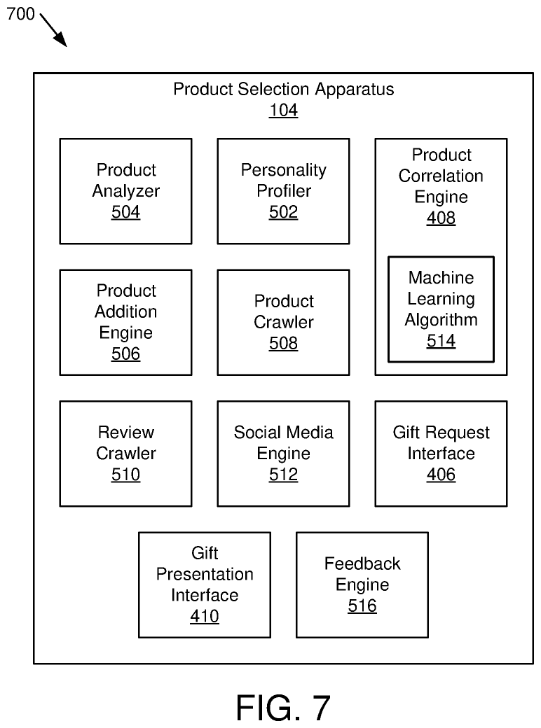

The product selection apparatus 104 analyzes data of a product to extract personality trait information associated with the product data and then analyzes information about users of the product to extract personality traits. The product selection apparatus 104 then correlates the personality traits of the users of the product with the product and/or correlates personality trait information from the product data with the product and then adds an entry for the product to the product database along with personality trait information correlated to the product. The product selection apparatus 104 is described in more detail below in relation to FIGS. 6 and 7.

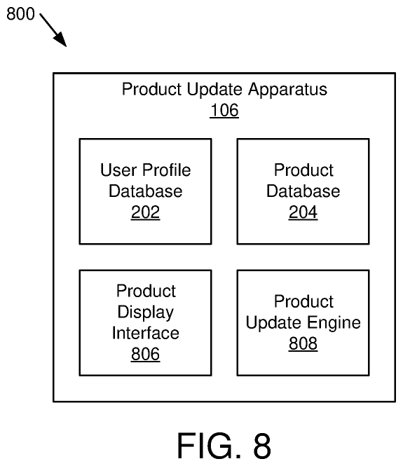

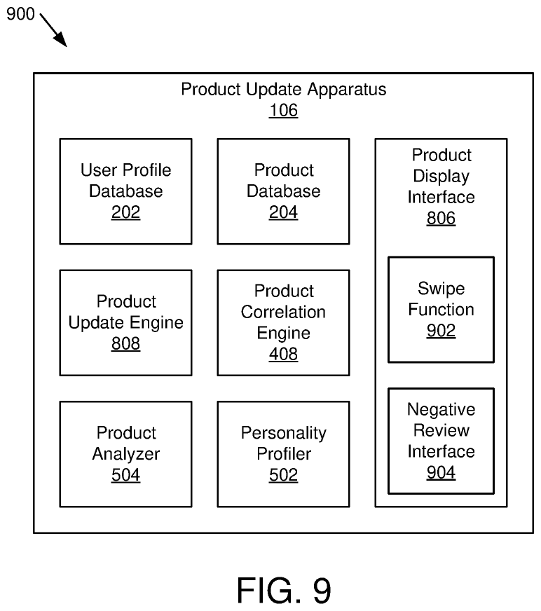

The product update apparatus 106 uses the user profile database and the product database and presents a product from the product database to a user with a user profile in the user profile database and then receives a positive or a negative review of the product. The product update apparatus 106 updates personality trait information of an entry in the product database for the product based on the user review. The product update apparatus 106 is described in more detail below in relation to FIGS. 8 and 9.

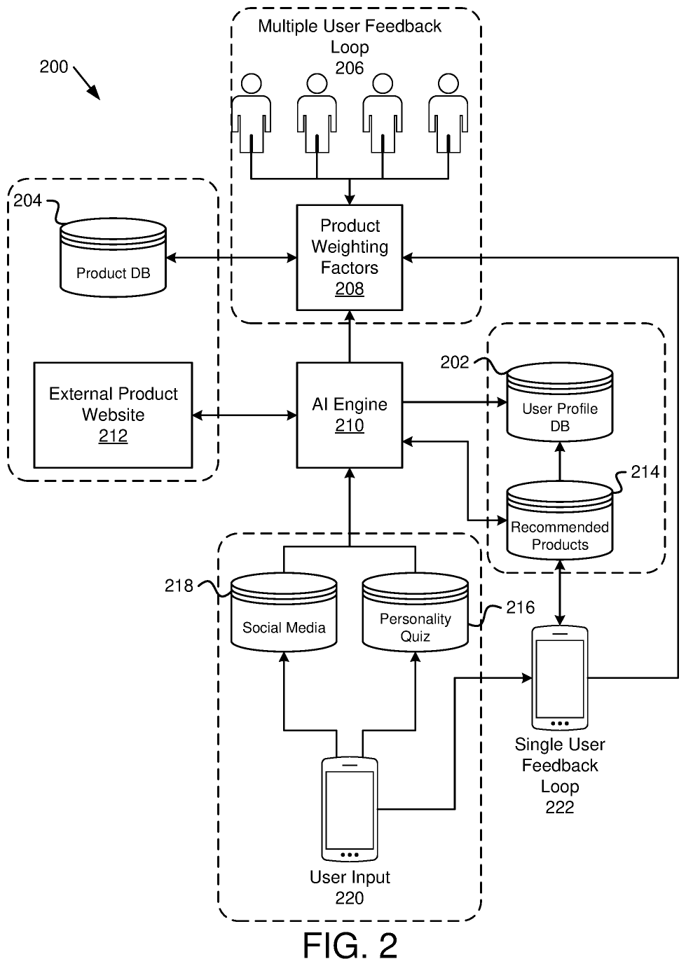

FIG. 2 is a schematic block diagram illustrating one embodiment of elements 200 of the system 100 of FIG. 1 for gift suggestions. The elements 200 include a user profile database 202, a product database 204, a multiple user feedback loop 206, product weighting factor 208, an artificial intelligence engine 210, external product websites 212, recommended products 214, a personality quiz 216, social media information 218, user input 220 and a single user feedback loop 222, which are described below.

The user profile database 202 includes basic profile information of users, such as name, email address, phone number, address, birthday, etc. An entry for a user also includes personality trait information linked to the user. The personality trait information of a user, in some embodiments, includes various personality traits of the user. For example, typical personality traits include adventurous, afraid, ambitious, fearless, polite, cautious, confident, spoiled, loyal, determined, mysterious, hard-working, clumsy, careful, brave, and the like.

In other embodiments, personality trait information includes ways that a gift receiver might feel appreciated, loved, cared for, etc. For some users, they might react to certain words of affirmation, like “good job,” “you are beautiful,” etc. For other users, they might respond to the gift giver providing some type of service to the gift receiver. Another gift receiver might react well to receiving a physical gift and might want an extravagant gift, a thoughtful gift, etc. Other gift receivers might want the gift giver's time. Other gift receivers might react to physical touch. In other embodiments, the personality trait information might be in the form of a certain classification within a quadrant system where each quadrant correlates to certain personality traits. The embodiments described herein include various ways to extract personality trait information of a user from various sources and then correlating the personality trait information of the user with products that correspond to the personality trait information of the user so that a gift giver is able to more effectively select a gift that will be appreciated by the gift receiver.

The product database 204 includes products that are available for sale to be given as gifts. An entry for a product in the product database 204 includes personality trait information correlated to the product of the product entry. The correlated personality trait information includes personality traits and similar information that have been correlated to the product such that a user with a particular personality trait receiving a product as a gift where the product is correlated to the same personality trait of the user will more likely result in the user appreciating the gift. This is in contrast to a user giving a gift guessing at what the user receiving the gift wants, which often results in the user receiving the gift not wanting the gift.

In some embodiments, each product entry in the product database 204 includes one or more product weighting factors 208 (or simply weighting factors 208) for each bit of personality trait information. For example, a product may include personality traits such as adventurous, fearless and spoiled, each personality trait may include a corresponding weighting factor 208. Each weighting factor 208 may then be set to a value that reflects how much the particular gift applies to the corresponding personality trait. For example, a climbing harness for rock climbing might rate high for an adventurous weighting factor 208 and a fearless weighting factor 208, but might be reasonably priced or may be relatively inexpensive and may have a relatively low for a spoiled weighting factor 208. In other embodiments, each product entry includes a weighting factor 208 for each bit of personality trait information. In the embodiments, many weighting factors 208 might not apply and may then have a weighting factor 208 that is low or zero. In the embodiments, the entries and weighting factors 208 may be in the form of a matrix and determining products as potential gifts for a gift receiver, determining product weighting factors 208, etc. may involve linear algebra or other matrix manipulation techniques.

The product weighting factors 208 are derived for a product and then entered or updated in the product database 204. The weighting factors 208 and potential products for the product database 204 are derived in a variety of ways. For example, data from an external product website 212 may be mined and analyzed by an artificial intelligence (“Al”) engine 210 to determine personality trait information from the product data, photographs, specifications, etc. on the external product website 212. In addition, reviews of the product from the external product website 212 may be used to identify personality trait information about the product as well as personality trait information about the reviewer, which is most likely a user of the product.

Social media information 218 may be used to identify product users and personality trait information may be extracted about the product users. The multiple user feedback loop 206 includes receiving feedback from various users in the user profile database 202 and from other users. The users may provide product feedback when the users may provide product feedback as users selecting a gift where the users may accept or reject certain products, the users may provide written feedback about the products, etc. For example, the users may preview products as potential gifts or products to purchase and may swipe right or left to provide positive or negative feedback about the products and the personality traits of the users along with other input from the users may be used to modify the product weighting factors 208.

User input 220, for example via a client 110, may be input to the user profile database for the user and may be used to provide answers to questions in a personality quiz 216, which may then be analyzed by the AI engine 210 to extract personality trait information about the user, which is input to the entry in the user profile database 202. Social media information 218 about the user may also be mined and analyzed by the AI engine 210 to extract personality trait information about the user, which is also input to the entry for the user in the user profile database 202. The single user feedback loop 222 includes when a user receives a product as a gift or when the user views recommended products 214 and provides feedback about the product(s). The feedback from the user is then used to update weighting factors 208 for the reviewed product(s). While the arrows for the multiple user feedback loop 206 and the single user feedback loop 222 are depicted pointing to the product weighting factors 208, the AI engine 210 may be used by the multiple user feedback loop 206 and the single user feedback loop 222 to extract personality trait information about the products for updating the product weighting factors 208.

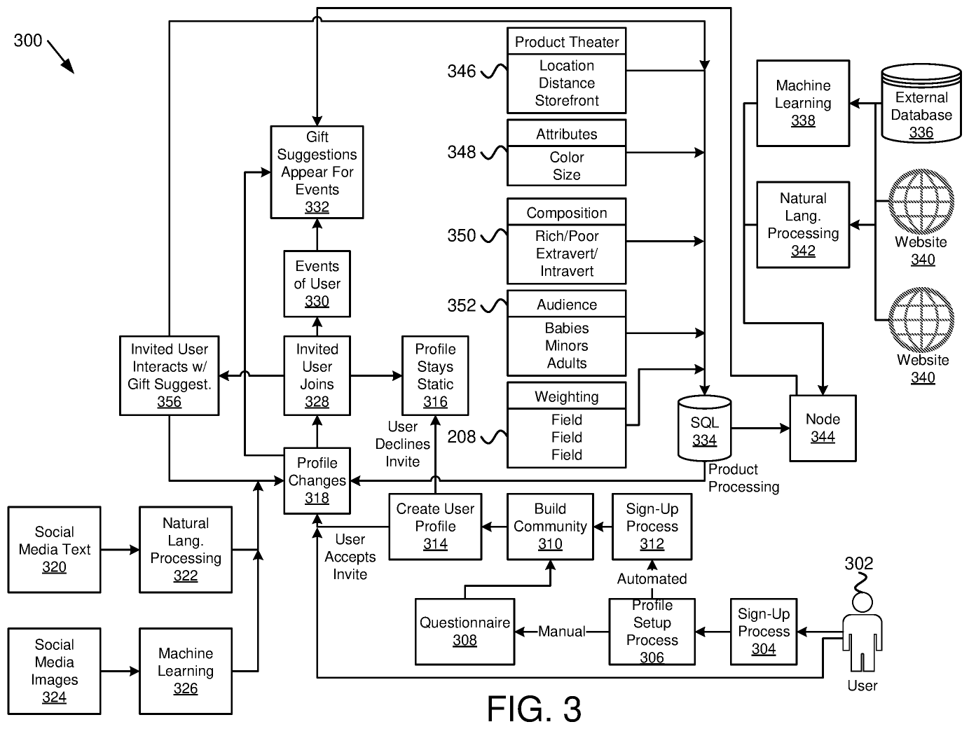

FIG. 3 is a schematic block diagram/flowchart diagram illustrating one embodiment of elements 300 of the system of FIG. 1 and method steps for gift suggestions. FIG. 3 is an expansion of FIG. 2 and provides additional information to supplement FIG. 2.

A user 302 starts with a sign-up process 304 where the user 302 inputs basic information. A profile setup process 306 begins creating a user profile in the user profile database 202. The user is presented a questionnaire 308 that is designed to identify personality trait information about the user 302. The personality trait information from the questionnaire 308 is processed by the AI engine 210 and input into the user profile of the user 302 along with other user input 220 from user 302 and helps build a community 310 of users 302. In addition, the sign-up process 312 may be automated in some aspects, such as gathering user data of the user 302 from social media text 320 and other locations. The user input from the sign-up process 304, personality trait information from the questionnaire 308, etc. is used to create a user profile 314.

Users 302 may invite others to join and may input contact information and other information about the invited user 302, which is used to create a user profile for the invited user 302. Where the user 302 accepts an invitation and inputs data, the user profile 318 changes. Where a user 302 is invited and declines an invitation, the user profile based on information from the user 302 creating the invite stays static 316. For example, a user 302 may invite 328 another user 302 and the invited user 302 may decline the invitation so the user profile stays static 316. Where the invited user 302 accepts the invitation, the process returns to the sign-up process 304.

In some embodiments, a social media crawler searches for social media text 320 about users 302 and a natural language processing engine 322 analyzes the social media text 320 to extract personality trait information and other information about the user 302, which causes the user profile to change 318. In other embodiments, social media images 324 are input in a machine learning engine 326, which also extracts personality trait information and other information about the user 302, which causes the user profile to change 318.

When a user 302 creates an invitation for another user 302, the user 302 creating the invitation may input events 330 of the invited user 302, such as a birthday, an anniversary, or other important date that may be a basis for a gift from a user 302. In other embodiments, user input 220 in the sign-up process 304 includes events 332 of the user 302 entering the user input 220. In some embodiments, an alert or other type of reminder of an event 330 of a second user 302b is sent to a first user 302a. The first user 302a interacts with the system 100 and the gift apparatus 102 presents one or more products in the form of gift suggestions for an upcoming event 330 to the first user 302a.

Personality trait information from a user profile of the second user 302b along with personality trait information correlated to products from the product database 204 are used to provide gift suggestions 332 for an upcoming event. The first user 302a is then able to select a presented product. The first user 302a is then able to purchase and/or send the product through gift apparatus 102 or website information 340 is transmitted to the first user 302a, for example by way of a link, to allow the first user 302a to purchase and/or send the selected product via the external website 340. In some embodiments, the gift apparatus 102 tracks the first user 302a going to the external website 340 so the owner of the external website 340 provides a referral fee to the gift apparatus 102.

Gift suggestions are from a product database 204 and a variety of means are used to populate the product database 204. Text from external databases 336 and/or websites 340 are processed using natural language processing 342 and machine learning 338 to select products for the product database 204 and to extract personality trait information about the products where the results are sent to a node 344 that includes access to the product database 204. Invited users 302 may also interact with gift suggestions 356, which may result in an updated user profile 318 or weighting factors 208. A SQL server 334 or similar relational database management system may be used by the node 344 in creating product entries in the product database 204. In some embodiments, each entry in the product database 204 includes personality trait information relevant to the product of the product entry. In other embodiments, each personality trait or other data of the personality trait information of an entry includes weighting factors 208 that may be adjusted through machine learning and/or the AI engine 210.

Various factors are considered for product entries that help to correlate personality traits and other data to the product of the product entry. For example, the product theater 346 is considered, such as the location of the product, distance from the user 302, whether or not the product is in a brick-and-mortar storefront or not, etc. Attributes 348 of a product are considered, such as color, size, etc. Composition 350 of the user 302 receiving the gift is also considered, such as whether the user 302 is rich or poor, whether the user 302 is an introvert or extravert, and the like. The audience 352 of the product is also considered, such as if the product is intended for babies, minors, adults, senior citizens, etc. Other factors regarding products for the database may also be also considered and machine learning may be used to adjust categories, attributes, weighting factors, etc. over time.

FIG. 4 is a schematic block diagram illustrating one embodiment of an apparatus 400 for gift suggestions. The apparatus 400 includes one embodiment of the gift apparatus 102 that includes a user profile database 202, a product database 204, a gift request interface 406, a product correlation engine 408 and a gift presentation interface 410, which are described below.

The apparatus 400 includes a user profile database 202 that includes a plurality of user profiles. Each user profile of a user 302 includes user data of the user 302 correlated with personality trait information of the user 302. In other embodiments, each user profile also includes other information about the user 302, such as an email address, a phone number, an address, social media pages of the user 302, events of the user, such as an anniversary, a birthday, etc. One or more of the user profiles may also include other relevant information about the user, such as demographic information, ethnicity information, user likes and dislikes received from the user, and other information relevant to selecting a gift for the user 302 that the user will enjoy, appreciate, etc. In some embodiments, the user profile database 202 is substantially similar to the user profile database 202 described above in relation to FIGS. 1-3.

The user profile database 202 is implemented with an appropriate data structure capable of including information about a user 302, related personality trait information about the user 302, and other user information. In some embodiments, the user profile database 202 is implemented with a data structure capable of including weighting factors 208. The user profile database 202 may be local to the server 108 or located in one or more external data storage devices 116. One of skill in the art will recognize ways to implement the user profile database 202.

The apparatus 400 includes a product database 204 that includes product entries of products where each product entry includes personality trait information correlated to the product. An entry in the product database 204 includes basic product information, such as product identification information, product location information, product pricing, etc. The entry also includes personality trait information useful in correlating the product with a user 302 with similar personality trait information. For example, if a user 302 has personality traits of adventurous, likes to travel, and enjoys physical gifts and a product is deemed to be for an adventurous person, is used when a person travels, and is an object rather than a service then the product may correlate with the user 302 and may be presented to a user 302 that is a gift giver as a potential gift.

The personality trait information for a product, in some embodiments, is based on product information from an external product website 212, 340. In other embodiments, the personality trait information for a product in the product database 204 is based on information about users of the product. For example, an external product website 212, 340 or other website may include product reviews for the website and language in the reviews and/or information about the reviewers may be used to derive personality trait information about the product. In various embodiments, the product database 204 may be implemented in a suitable data structure similar to the data structures described above in relation to the user profile database 202. In some embodiments, the product database 204 is substantially similar to the product database 204 discussed in relation to FIGS. 1-3.

The apparatus 400 includes a gift request interface 406 configured to receive from a first user 302a a request to recommend a gift to a second user 302b. The second user 302b has a user profile in the user profile database 202. For example, the first user 302a may want to give a gift to the second user 302b based on an event of the second user 302b or another reason and may access the gift apparatus 102. For example, the first user 302a may log in to a website of the gift apparatus 102. The first user 302a may then pick a user in the user profile database 202 as the second user 302b as a recipient of a gift.

The gift request interface 406 displays a mechanism to select the second user 302b. For example, the gift request interface 406 may include a search bar to search for the second user 302b. In other embodiments, the gift request interface 406 includes a menu, list, or the like where the first user 302a can scroll to or otherwise locate the second user 302b. In some embodiments, selection of the second user 302b signifies that the first user 302a is selecting the second user 302b for recommendations of a gift. In other embodiments, once the second user 302b is selected, the gift request interface 406 presents options to the first user 302a where at least one of which is an indication that the first user 302a wants gift recommendations fora gift for the second user 302b. One of skill in the art will recognize other ways for the gift request interface 406 to receive a request from the first user 302a for gift recommendations related to the second user 302b.

The apparatus 400 includes a product correlation engine 408 configured to correlate one or more products from the product database 204 with the second user 302b based on the personality trait information of the user profile of the second user 302b. The product correlation engine 408, in some embodiments, correlates specific personality traits of the second user 302b to corresponding personality traits associated with one or more products. In other embodiments, the product correlation engine 408 uses product weighting factors 208 of various products along with personality trait information of the second user 302b to correlate one or more products with the second user 302b.

In other embodiments, the product correlation engine 408 uses a scoring system to score products in the product database 204 based on personality trait information of the second user 302b and then identifies products that have a score above a product score threshold. For example, the second user 302b may include several personality traits or similar personality trait metrics and the product correlation engine 408 scores products based on the personality traits and personality trait metrics of the second user 302b. The product correlation engine 408 may select products in the product database 204 with the same personality traits as the second user 302b and then may average the weighting factors 208 of the personality traits of a product that match the personality traits of the second user 302b to determine a personality trait score for the product.

In some embodiments, the user profile database includes user profiles that have weighting factors 208 for the personality trait information of the users 302. For example, the user profile of the second user 302b may include personality traits of timid, careful and ambitious along with a weighting factor 208 for each of the personality traits. The weighting factors 208, in some embodiments, are between 0 and 1 the weighting factor 208 for timid may be 0.8, for careful may be 0.7, and for ambitious may be 0.2. In the embodiment, the product correlation engine 408 may further multiply the weighting factors 208 of the personality traits of the second user 302b by corresponding weighting factors of product traits of a product to determine a personality trait score for the product. The product correlation engine 408 may then select products for recommendation that have a personality trait score above a personality trait score threshold. In other embodiments, the product correlation engine 408 selects a group of products for recommendation that have a highest personality trait score. For example, the product correlation engine 408 may select the top ten products for recommendation. One of skill in the art will recognize other ways for the product correlation engine 408 to correlate products for recommendation to the first user 302a based on personality trait information of the second user 302b.

The apparatus 400 includes a gift presentation interface 410 configured to display to the first user 302a the one or more products from the product database 204 correlated to the second user 302b. In one embodiment, the gift presentation interface 410 presents gifts identified by the product correlation engine 408 serially. In other embodiments, the gift presentation interface 410 presents gifts identified by the product correlation engine 408 in a list, in a table format, or other display type with multiple recommended products displayed. In other embodiments, the gift presentation interface 410 presents gifts on a same webpage, account, etc. of the gift apparatus 102 used by the gift request interface 406. One of skill in the art will recognize other ways for the gift presentation interface 410 to display to the first user 302a the one or more products from the product database 204 correlated to the second user 302b.

FIG. 5 is a schematic block diagram illustrating another embodiment of an apparatus 500 for gift suggestions. The apparatus 500 includes another embodiment of the gift apparatus 102 that includes a user profile database 202, a product database 204, a gift request interface 406, a product correlation engine 408, and a gift presentation interface 410 that are substantially similar to those described above in relation to the apparatus 400 of FIG. 4. In various embodiments, the embodiment of the gift apparatus 102 includes a personality profiler 502, a product analyzer 504, a product addition engine 506, a product crawler 508, a review crawler 510, a social media engine 512, a machine learning algorithm in the product correlation engine 408, a feedback engine 516, a gift message engine 518, a gift selection interface 520, and/or a gift purchase engine 522, which are described below.

The apparatus 500, in some embodiments, includes a personality profiler 502 configured to receive information from a user 302 and to analyze the information from the user 302 to identify personality trait information of the user and configured to add the personality trait information of the user 302 to a user profile of the user 302. In some embodiments, the information from the user 302 includes answers to queries presented to the user 302 where the queries and/or answers to the queries are configured to identify personality trait information of the user being presented the queries. For example, the personality profiler 502 may present queries from the personality quiz 216 an/or questionnaire 308 of FIGS. 2 and 3.

The apparatus 500, in some embodiments, includes a product analyzer 504 configured to analyze product data of a product to be added to the product database 204 to determine personality trait information associated with the product data. In some embodiments, the product analyzer 504 uses product data about a product from external product websites 212, 340 to determine the personality trait information associated with the product data of the product. In other embodiments, the product analyzer 504 uses reviews of the product from external product websites 212, 340 and/or from other websites with product reviews to determine the personality trait information associated with the product data of the product.

In other embodiments, the personality profiler 502 is configured to analyze information about users of the product to extract personality trait information from the information about the users of the product. For example, the personality profiler 502 may analyze information about a user of a product that left a review of the product to determine personality trait information of the user of the product that left the review. In other embodiments, the personality profiler 502 is configured to analyzer information about users 302 of the product in the user profile database 202 to determine personality trait information of the user of the product that left the review.

In some embodiments, the product correlation engine 408 is configured to correlate the personality trait information of the users of the product with the product. In some examples, the product correlation engine 408 uses personality trait information from the personality profiler 502 about users of the product. In other embodiments, the product correlation engine 408 is configured to correlate personality trait information from the product data with the product. In some examples, the product correlation engine 408 uses personality trait information determined by the product analyzer 504 from product data of the product.

The apparatus 500 includes, in some embodiments, a product addition engine 506 configured to insert product information of the product and associated personality trait information in an entry in the product database 204. For example, once the product analyzer 504 analyzes product data of a product and determines personality trait information associated with the product data, the personality profiler 502 analyzes information about users of the product to extract personality trait information from the information about the users, and the product correlation engine 408 correlates this personality trait information with the product, the product addition engine 506 then adds the product to the product database 204 with product information and correlated personality trait information.

The apparatus 500, in some embodiments, includes a product crawler 508 configured to search websites (e.g., 212, 340) for potential products to be added to the product database 204 and to input the potential products to the product analyzer 504. For example, the product crawler 508 may, over time, crawl through Internet websites in search of potential products and may analyze various websites to find product for sale that include a product description, product data, product specifications, etc. and then may input or otherwise notify the product analyzer 504 of the product. In some embodiments, the product crawler 508 searches for updates to webpages of products and determines if the particular webpage has enough information or the right information for the product of the webpage to become a candidate for the product database 204.

The apparatus 500, in some embodiments, includes a review crawler 510 configured to find reviews of a product and the product analyzer 504 uses the reviews to extract personality trait information about users of the product. In some examples, the review crawler 510 examines a webpage of a product to find reviews and may reexamine the webpage to determine if there is a new review of the product. In other embodiments, the review crawler 510 finds reviews of the product from other websites that include product reviews.

The apparatus 500, in some embodiments, includes a social media engine 512 configured to locate social media information about the users of a product and the personality profiler 502 extracts personality trait information of the users of the product from the social media information. For example, the review crawler 510 may identify a review of a product where the reviewer is a user of a product. The social media engine 512 then searches social media websites for the reviewer that uses the product and then identifies to the personality profiler 502 the webpage of the user of the produce on the social media website for the personality profiler 502 to then analyze information on the social media webpage of the user of the product to determine personality trait information of the user of the product.

The apparatus 500, in some embodiments, includes a product correlation engine 408 with a machine learning algorithm 514 configured to update the weighting factors 208 based on personality trait information of users of the products in the product database and/or reviews from users of the product. The machine learning algorithm 514, in certain embodiments, is configured to update the weighting factors 208 of a product over time as more reviews of the product and users of the product are identified. The machine learning algorithm 514, in some embodiments, includes a deep neural network where product review information, personality trait information of users of the product, and other relevant information about the product are used as input to the deep neural network to update the weighting factors.

The apparatus 500, in some embodiments, includes a feedback engine 516 configured to solicit a review from the second user 302b after the second user 302b has received a gift selected by the first user 302a. The product correlation engine 408 uses information from the review in correlating the selected gift with another user. For example, the product correlation engine 408 may use personality trait information about the second user 302b in a similar way as personality trait information from other users of the product from reviews on websites. In other examples, the product correlation engine 408 may use information in the product review from the second user 302b in a similar way as reviews from other users of the product from reviews on web sites.

The apparatus 500, in some embodiments, includes a gift message engine 518 configured to send a message to the first user 302a prior to an event in the user profile of the second user 302b. The message includes, in some embodiments, a reminder of the event of the second user 302b. In some embodiments, the message includes a display of one or more products from the product database 204 correlated to the second user 302b. In other embodiments, the message includes a link to a website of the gift apparatus 102 for the first user 302 to log into so that the first user 302a is then presented with one or more products from the product database 204 correlated to the second user 302b. One of skill in the art will recognize other forms of the message.

The apparatus 500, in some embodiments, includes a gift selection interface 520 configured to receive a gift selection from the first user 302a for purchase by the first user 302. The gift selection, in some embodiments, is for a product of the one or more products correlated to the second user 302b. In other embodiments, the gift selection interface 520 receives a gift selection for a product not correlated to the second user 302b where the selected gift is for a product in the product database 204.

The apparatus 500, in some embodiments, includes a gift purchase engine 522 configured to send shipping instructions for a gift selected by the first user in response to the first user purchasing a selected gift. In other embodiments, the gift purchase engine 522 includes an interface to allow the first user 302a to purchase the selected gift and may include a credit card/debit card transaction module that allows the first user 302a to enter credit card or debit card information and other relevant information for a transaction for purchase of the selected gift by the first user 302a. The gift purchase engine 522 includes an interface to display the name of the second user 302b and other relevant information for shipment of the selected gift to the second user 302b. In some embodiments, the gift purchase engine 522 allows the first user 302a to enter or modify address information or other information about the second user, to select a shipping address, to select a shipping method, etc.

FIG. 6 is a schematic block diagram illustrating one embodiment of an apparatus 600 for product selection for a database for gift suggestions. The apparatus 600 includes an embodiment of the product selection apparatus 104 with a product analyzer 504, a personality profiler 502, a product correlation engine 408 and a product addition engine 506, which are described below.

The apparatus 600 includes a product analyzer 504 configured to analyze product data of a product to extract personality trait information associated with the product data. In some embodiments, the product data is from an external product website 212. In other embodiments, the product data is from a spec sheet for the product. In other embodiments, the product data is from a description of the product on a third-party website. In other embodiments, the product data is from a review of the product. In other embodiments, the product data is input by a system administrator or other person based on observations of the product.

In some embodiments, the product data is text and the product analyzer 504 includes a natural language processing engine 342, 322 of the text to extract the personality trait information. In other embodiments, the product data includes one or more images and the product analyzer 504 includes image processing to identify traits of the product in a format that the product analyzer 504 is able to extract personality trait information. In other embodiments, the product data includes sound data and the product analyzer 504 processes the sound data to create product data in a format for extracting personality trait information.

In other embodiments, the product analyzer 504 extracts personality trait information based on traits of the product. Traits of the product may include size, color, intended use, cost of the product, complexity of use of the product, whether the product is an entry level version, an intermediate version, a deluxe version, whether the product is intended for indoor use, outdoor use, etc., whether the product requires training for use, and other traits. In other embodiments, the product analyzer 504 is substantially similar to the product analyzer 504 of FIG. 5.

The apparatus 600 includes a personality profiler 502 configured to analyze information about users of the product to extract personality traits from the information about the users of the product. In some examples, the personality profiler 502 analyzes information from a review of the product to extract personality trait information. In other embodiments, the personality profiler 502 identifies users of the product from identity information in a review and then analyzes social media information of the reviewer to extract personality trait information about the reviewer. In other embodiments, the personality profiler 502 is substantially similar the personality profiler 502 of FIG. 5.

The apparatus 600 includes a product correlation engine 408 configured to, in some embodiments, correlate the personality trait information of the users of the product with the product. In other embodiments, the product correlation engine 408 is configured to correlate personality trait information from the product data with the product. In some embodiments, the product correlation engine 408 is substantially similar to the product correlation engine 408 of FIGS. 4 and 5 and may include a machine learning algorithm 514 as describe in relation to FIG. 5.

The apparatus 600 includes a product addition engine 506 configured to insert product information of the product and associated personality trait information in an entry to a product database 204. For example, after the product correlation engine 408 correlates personality trait information with a product, the product addition engine 506 adds the product, product information, and relate personality trait information to the product database 204. In some embodiments, the product addition engine 506 is substantially similar to the product addition engine 506 of FIG. 5.

FIG. 7 is a schematic block diagram illustrating another embodiment of an apparatus 700 for product selection for a database for gift suggestions. The apparatus 700 includes an embodiment of the product selection apparatus 104 with a product analyzer 504, a personality profiler 502, a product correlation engine 408 and a product addition engine 506, which are substantially similar to those described above in relation to FIGS. 4-6. The embodiment of the product selection apparatus 104 also includes a product crawler 508, a review crawler 510, a social media engine 512, a machine learning algorithm 514 in the product correlation engine 408, a gift request interface 406, a gift presentation interface 410 and/or a feedback engine 516, which are substantially similar to those described above in relation to FIGS. 4 and 5.

FIG. 8 is a schematic block diagram illustrating one embodiment of an apparatus 800 for correlating personality traits with products of a database for gift suggestions. The apparatus 800 includes an embodiment of the product update apparatus 106 with a user profile database 202, a product database 204, a product display interface 806, and a product update engine 808, which are described below.

The apparatus 800 includes a user profile database 202 with a plurality of user profiles where each user profile of a user 302 includes user data of the user 302 correlated with personality trait information of the user 302. The apparatus 800 includes a product database 204 with product entries of products where each product entry includes personality trait information correlated to the product. The user profile database 202 and the product database 204 are substantially similar to those described in relation to FIGS. 2-7.

The apparatus 800 includes a product display interface 806 configured to present a product from the product database 204 to a user 302 with a user profile in the user profile database 202 and to receive a user review from the user 302 where the user review includes a positive review or a negative review of the product. In some embodiments, the user 302 is a first user 302a selecting a product as a gift for a second user 302b. In the embodiment, the product display interface 806 presents the first user 302a with an opportunity to review one or more products correlated to the second user 302b and receives a review of the one or more products from the first user 302a. In other embodiments, the user 302 is a second user 302b that received the product as a gift and the product display interface 806 presents the second user 302b with an opportunity to review the received product.

In other embodiments, the product display interface 806 presents a product from the product database 204 to a user 302 independent of the user 302 being a first user 302a giving a gift or a second user 302b receiving a gift. For example, the product display interface 806 may present the product to a user 302 that on a webpage of the product update apparatus 106. The webpage, in some embodiments, is on a website for the gift apparatus 102 and/or the product selection apparatus 104.

The apparatus 800 includes a product update engine 808 configured to update personality trait information of an entry for the product in the product database 204 based on the user review from the user 302. In some embodiments, the product database 204 includes product weighting factors 208 and the product update engine 808 updates the product weighting factors 208 for the product based on the user review. In other embodiments, the product update engine 808 considers whether or not the product review is a positive or a negative review along with personality traits of the user 302 in updating the personality trait information. In some embodiments, the product update engine 808 weights negative reviews more than positive reviews. Typically, a negative review provides more information than a positive review due to emotions involved in the negative review. However, some positive reviews that are well thought out also provide useful information.

The product update engine 808, in some embodiments, uses personality trait information of the user 302 providing the review along with the review to update the personality trait information of the product. For example, the user 302 may have a personality trait of being adventurous and a negative review from the user 302 may indicate that the product is not for an adventurous person so the product update engine 808 updates the personality trait information and/or weighting factors 208 of the product to indicate that the product is not for an adventurous person. Where the review is a positive review, the product update engine 808 may update weighting factors and/or personality trait information of the product to indicate that the product is for an adventurous person. In other embodiments, the product update engine 808 uses multiple reviews of the product to update personality trait information and/or weighting factors 208 of a product improve accuracy of the updates by the product update engine 808.

In some examples, the product update engine 808 includes a machine learning algorithm that considers multiple reviews, personality trait information of the users 302, various personality traits and other data of personality trait information of a product, negative versus positive review, and the like to update personality trait information and/or weighting factors 208 of a product. In other embodiments, the machine learning algorithm uses user reviews from one or more websites 212, 340 along with personality trait information derived from webpages with information about the users providing the user reviews from the one or more websites 212, 340.

FIG. 9 is a schematic block diagram illustrating another embodiment of an apparatus 900 for correlating personality traits with products of a database for gift suggestions. The apparatus 900 includes another embodiment of the product update apparatus 106 with a user profile database 202, a product database 204, a product display interface 806, a product update engine 808, a product correlation engine 408, a product analyzer 504 and a personality profiler 502, which are substantially similar to those described above in relation to FIGS. 2-8. The product display interface 806, in various embodiments, includes a swipe function 902 and/or a negative review interface 904, which are described below.

The product display interface 806, in some embodiments includes a swipe function 902. In response to the user 302 swiping a first direction on a display of the product, the product display interface 806 interprets the swipe in the first direction as a positive review of the product. In response to the user 302 swiping a second direction on the display of the product, the product display interface 806 interprets the swipe in the second direction as a negative review of the product and the first direction is opposite the second direction. The user 302 swiping right, in some embodiments, indicates a positive review and swiping left indicates a negative review. Other embodiments may be the opposite or may require a swipe up or down for a positive or negative review.

Where the product display interface 806 includes a swipe function 902, the product display interface 806 may be designed for displaying numerous products and the swipe function 902 allows for quick reviews. In other embodiments, the product display interface 806 displays a product, product data, a video, etc. before allowing a swipe or before displaying an area for a swipe. One of skill in the art will recognize other ways for the product display interface 806 to utilize a swipe function 902.

In some embodiments, the product display interface 806 includes a negative review interface 904 configured to receive from the user 302 reasons for the negative review of the product provided by the user 302 and the product update engine 808 updates the personality trait information of the entry for the product based on the reasons for the negative review received from the user 302. For example, once the user 302 swipes left indicating a negative review or other indication of a negative review, the negative review interface 904 presents an opportunity to explain the negative review and the product update engine 808 uses the negative review to update the personality trait information and/or weighting factors 208 of the product based on the negative review. In some embodiments, the product update engine 808 uses the product correlation engine 408, personality profiler 502, etc. in determining how to update the personality trait information and/or weighting factors 208 of the product.

In other embodiments, the negative review interface 904 is configured to provide a list of reasons for a negative review by the user 302 and to receive a selection of one or more reasons on the list. The product update engine 808 is configured to update the personality trait information of the entry for the product based on the selected reason or reasons for the negative review received from the user 302. Again, the product update engine 808 may use the product correlation engine 408, personality profiler 502, etc. in determining how to update the personality trait information and/or weighting factors 208 of the product.

In embodiment involving giving a gift, once a first user 302a has rejected a product correlated to the second user 302b, the product display interface 806 presents the first user 302a with an opportunity to explain why the product was rejected. In other embodiments, the product display interface 806 uses rejection of the product by the first user 302a as a negative review. In other embodiments, the user 302 is a second user 302b that received the product as a gift and the product display interface 806 presents the product to the second user 302b to receive a review. Advantageously, the product update apparatus 106 provides a mechanism to solicit reviews from users 302 to improve correlation between personality trait information of users and products.

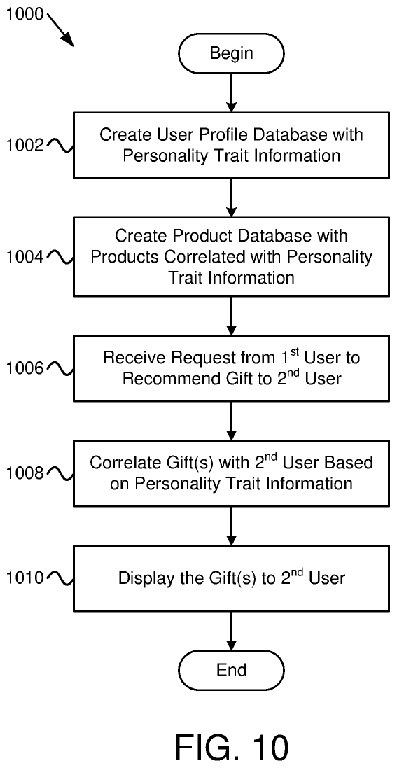

FIG. 10 is a schematic flowchart diagram illustrating one embodiment of a method 1000 for gift suggestions. The method 1000 begins and creates 1002 a user profile database 202 with a plurality of user profiles. Each user profile of a user 302 includes user data of the user 302 correlated with personality trait information of the user 302. The method 1000 creates 1004 a product database 204 with product entries of products. Each product entry includes personality trait information correlated to the product. The method 1000 receives 1006 from a first user 302a a request to recommend a gift to a second user 302b where the second user 302b has a user profile in the user profile database 202. The method 1000 correlates 1008 one or more products from the product database 204 with the second user 302b based on the personality trait information of the user profile of the second user 302b. The method 1000 displays 1010 to the first user 302a the one or more products from the product database 204 correlated to the second user 302b, and the method 1000 ends. In various embodiments, the method 1000 is implemented by one or more of the user profile database 202, the product database 204, the gift request interface 406, the product correlation engine 408 and the gift presentation interface 410.

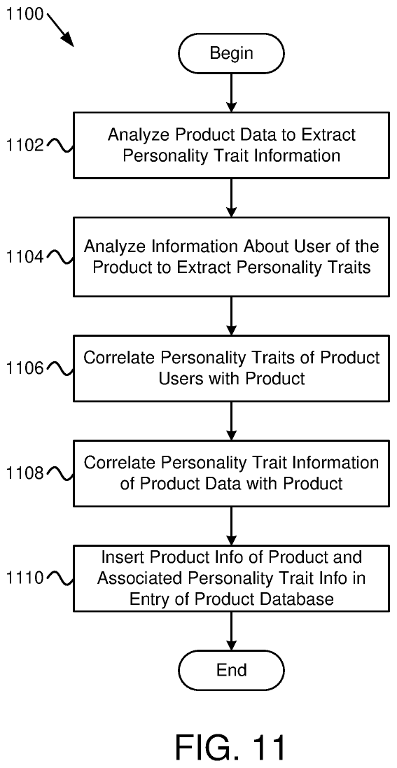

FIG. 11 is a schematic flowchart diagram illustrating one embodiment of a method 1100 for product selection for a database for gift suggestions. The method 1100 begins and analyzes 1102 product data of a product to extract personality trait information associated with the product data and analyzes 1104 information about users of the product to extract personality traits from the information about the users of the product. The method 1100 correlates 1106 the personality trait information of the users of the product with the product and/or correlate 1108 personality trait information from the product data with the product. The method 1100 inserts 1110 product information of the product and associated personality trait information in an entry to a product database 204, and the method 1100 ends. In various embodiments, the method 1100 is implemented by one or more of the product analyzer 504, the personality profiler 502, the product correlation engine 408 and the product addition engine 506.

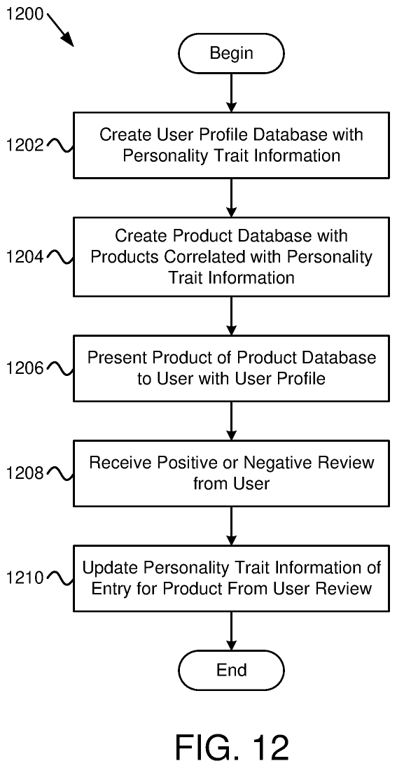

FIG. 12 is a schematic block diagram illustrating one embodiment of a method 1200 for updating personality traits with products of a database for gift suggestions. The method 1200 begins and creates 1202 a user profile database 202 with a plurality of user profiles. Each user profile of a user 302 includes user data of the user 302 correlated with personality trait information of the user 302. The method 1200 creates 1204 a product database 204 with product entries of products. Each product entry includes personality trait information correlated to the product. The method 1200 presents 1206 a product from the product database to a user 302 with a user profile in the user profile database 202 and receives 1208 a user review from the user 302. The user review is a positive review or a negative review of the product. The method 1200 updates 1210 personality trait information of an entry for the product in the product database based on the user review from the user 302, and the method 1200 ends. In various embodiments, the method 1200 is implemented by one or more of the user profile database 202, the product database 204, the product display interface 806 and the product update engine 808.

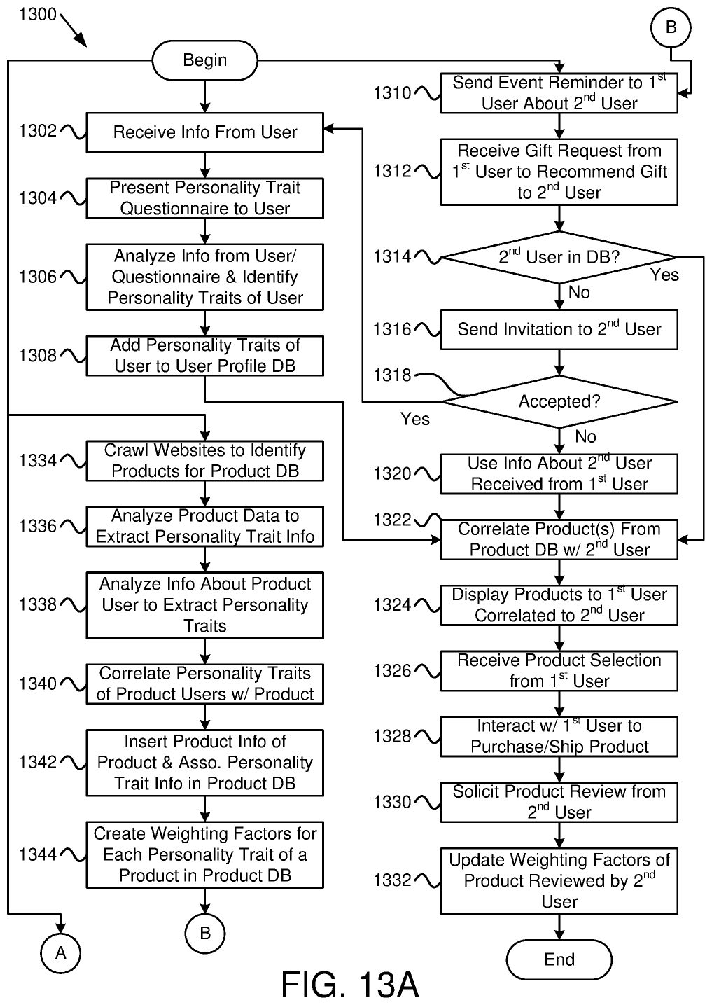

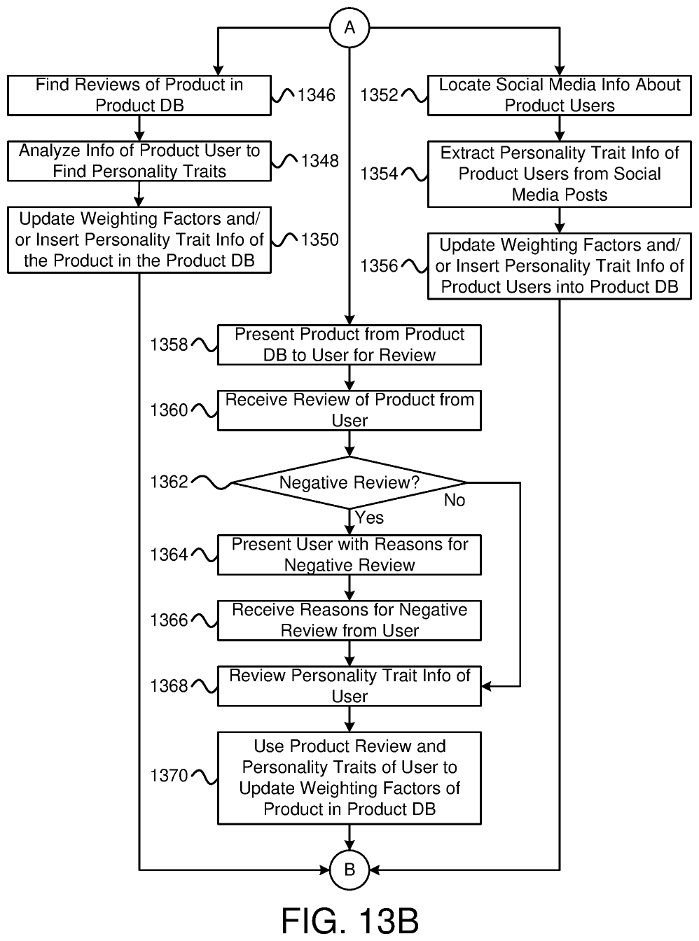

FIG. 13A is a first part and FIG. 13B is a second part of a schematic block diagram illustrating another embodiment of a method 1300 for gift selections, for product selection for a database for gift suggestions, and for correlating personality traits with products of a database for gift suggestions. The method 1300 begins and receives 1302 information from a user 302. The information received 1302 from the user 302 may include contact information, address information, events of the user 302, and the like. The method 1300 presents 1304 a personality trait questionnaire 216, 308 to the user 302. The method 1300 again receives 1302 information from the user 302 in the form of answers to the questionnaire 216, 308 and analyzes 1306 the information from the user 302 to identify personality trait information of the user 302 and adds 1308 the personality trait information along with the contact information, events, etc. of the user 302 to a user profile of the user. The method 1300 repeats steps 1302 to 1308 for each user 302. Each user 302 includes a user profile in the user profile database 202.

The method 1300 optionally sends 1310 a message to a first user 302a prior to an event where the message includes a reminder of the event of a second user 302b. Where the method 1300 sends 1310 the message, either the first user 302a created a user profile for the second user 302b with the event or the user profile database 202 includes a user profile of the second user 302b with one or more events associated with the second user 302b. The method 1300 receives 1312 from the first user 302a a request to recommend a gift to a second user 302b. The method 1300 determines 1314 if the second user has created or added to a user profile in the user profile database 202. Where the first user 302a has created the user profile for the second user 302b, which typically would have personality trait information about the second user 302b, the second user 302b may not have added to the user profile, filled out the questionnaire 216, 308. In another embodiment, the first user 302a, upon sending the request to recommend a gift for the second user 302b, the second user 302b may not be in the user profile database 202 and the first user 302a merely includes an email address or other contact means to contact the second user 302b requesting joining and creating a user profile.

Where the method 1300 determines 1314 that there is not a user profile for the second user 302b, the method 1300 sends 1316 an invitation to the second user 302b to provide information and to fill out the questionnaire 216, 308. The method 1300 then determines 1318 if the invitation has been accepted by the second user 302b. If the method 1300 determines 1318 that the invitation has been accepted, the method 1300 returns and receives 1302 information from the second user 302b, presents 1304 the questionnaire 216, 308, etc. If the method 1300 determines 1318 that the second user 302b has not accepted the invitation, the method 1300 uses 1320 information about the second user 302b provided by the first user 302a and correlates 1322 one or more products from the product database 204 with the second user 302b based on the personality trait information of the limited user profile of the second user 302b. If the method 1300 determines 1314 that the second user 302b has a user profile input by the second user 302b, the method 1300 correlates 1322 one or more products from the product database 204 with the second user 302b based on the personality trait information of the user profile of the second user 302b from steps 1302 to 1308.

The method 1300 displays 1324 to the first user the one or more products from the product database 204 correlated to the second user 302b and receives 1326 a product selection from the first user 302a. The method 1300 then interacts 1328 with the first user 302a to purchase and/or ship the product to the second user 302b. The method 1300 solicits 1330 a product review from the second user 302b about the product that the second user 302b received from the first user 302a and updates 1332 weighting factors of the product reviewed by the second user 302b, and the method 1300 ends.

After beginning, the method 1300 also crawls 1334 websites for potential products to be added to the product database 204 and analyzes 1336 product data of a product to extract personality trait information associated with the product data and analyzes 1338 information about users of the product to extract personality traits from the information about the users of the product. The method 1300 correlates 1340 the personality trait information of the users of the product with the product and/or correlate 1340 personality trait information from the product data with the product and inserts 1342 insert product information of the product and associated personality trait information in an entry to a product database 204. The method 1300 creates 1344 a weighting factor 208 for each personality trait of the personality trait information correlated to the product entry. In some embodiments, a machine learning algorithm 338, 514 updates the weighting factors based on personality trait information of users of the products in the product database 204 and/or reviews from users of the product. The method 1300 returns (follow “B” to “B” on FIG. 13A) to optionally send 1310 an event reminder to the first user 302a or receives 1312 a request from the first user 302a to recommend a gift to the second user 302b.

After beginning, the method 1300 also finds 1346 (follow “A” on FIG. 13A to “A” on FIG. 13B) reviews of a product in the product database 204 and analyzes 1348 the reviews to extract personality trait information about users of the product and updates 1350 weighting factors 208 and/or personality trait information of the product in the product database 204 and the method 1300 returns (follow “B” on FIG. 13B to “B” on FIG. 13A) to optionally send 1310 an event reminder to the first user 302a or receives 1312 a request from the first user 302a to recommend a gift to the second user 302b.

After beginning, the method 1300 also locates 1352 social media information about the users of the product and extracts 1354 personality trait information of the users of the product from the social media information and updates 1356 weighting factors 208 and/or personality trait information of the product in the product database 204 and the method 1300 returns (follow “B” on FIG. 13B to “B” on FIG. 13A) to optionally send 1310 an event reminder to the first user 302a or receives 1312 a request from the first user 302a to recommend a gift to the second user 302b.

After beginning, the method 1300 also presents 1358 a product from the product database 204 to a user 302 with a user profile in the user profile database 202 and receives 1360 a user review from the user 302. The method 1300 determines 1362 if the user review is a negative review. If the method 1300 determines 1362 that the user review is negative, the method 1300 presents 1364 the user 302 with reasons for the negative review and receives 1366 from the user 302 one or more reasons that the user gave the negative review and reviews 1368 personality traits of the user 302. If the method 1300 determines 1362 that the user review is positive, the method 1300 reviews 1368 personality traits of the user 302. The method 1300 uses 1370 the user review and personality traits of the user 302 to update weighting factors 208 of the product in the product database 204 and the method 1300 returns (follow “B” on FIG. 13B to “B” on FIG. 13A) to optionally send 1310 an event reminder to the first user 302a or receives 1312 a request from the first user 302a to recommend a gift to the second user 302b.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a user profile database comprising a plurality of user profiles, each user profile of a user comprising user data of the user correlated with personality trait information of the user;
a product database comprising product entries of products, each product entry comprising personality trait information correlated to the product;
a gift request interface configured to receive from a first user a request to recommend a gift to a second user, the second user having a user profile in the user profile database;
a product correlation engine configured to correlate one or more products from the product database with the second user based on the personality trait information of the user profile of the second user; and
a gift presentation interface configured to display to the first user the one or more products from the product database correlated to the second user.

2. The apparatus of claim 1, further comprising a personality profiler configured to receive information from a user and to analyze the information from the user to identify personality trait information of the user and configured to add the personality trait information of the user to a user profile of the user.

3. The apparatus of claim 2, wherein the information from the user comprises answers to queries presented to the user, wherein the queries and/or answers to the queries are configured to identify personality trait information of the user being presented the queries.

4. The apparatus of claim 1, wherein the personality trait information correlated to a product in the product database comprises personality trait information of other users that have used the product.

5. The apparatus of claim 1, further comprising:
a product analyzer configured to analyze product data of a product to be added to the product database to determine personality trait information associated with the product data;
a personality profiler configured to analyze information about users of the product to extract personality trait information from the information about the users of the product;
wherein the product correlation engine is further configured to correlate the personality trait information of the users of the product with the product and/or to correlate personality trait information from the product data with the product; and
a product addition engine configured to insert product information of the product and associated personality trait information in an entry in the product database.

6. The apparatus of claim 5, further comprising a product crawler configured to search websites for potential products to be added to the product database and to input the potential products to the product analyzer.

7. The apparatus of claim 5, further comprising:
a review crawler configured to find reviews of the product, wherein the product analyzer uses the reviews to extract personality trait information about users of the product; and/or
a social media engine configured to locate social media information about the users of the product, wherein the personality profiler extracts personality trait information of the users of the product from the social media information.

8. The apparatus of claim 1, wherein each product entry of the product database comprises a weighting factor for each personality trait of the personality trait information correlated to the product entry and wherein the product correlation engine further comprises a machine learning algorithm configured to update the weighting factors based on personality trait information of users of the products in the product database and/or reviews from users of the product.

9. The apparatus of claim 1, further comprising a feedback engine configured to solicit a review from the second user after the second user has received a gift selected by the first user, wherein the product correlation engine uses information from the review in correlating the selected gift with another user.

10. The apparatus of claim 1, wherein a user profile of the second user in the user profile database comprises at least one event associated with the second user and further comprising a gift message engine configured to send a message to the first user prior to the event, the message comprising a reminder of the event of the second user and/or the display of the one or more products from the product database correlated to the second user.

11. The apparatus of claim 1, further comprising:
a gift selection interface configured to receive a gift selection from the first user for purchase by the first user, the gift selection comprising a product of the one or more products correlated to the second user; and
a gift purchase engine configured to send shipping instructions for a gift selected by the first user in response to the first user purchasing the selected gift.

12. A method comprising:
creating a user profile database comprising a plurality of user profiles, each user profile of a user comprising user data of the user correlated with personality trait information of the user;
creating a product database comprising product entries of products, each product entry comprising personality trait information correlated to the product;
receiving from a first user a request to recommend a gift to a second user, the second user having a user profile in the user profile database;
correlating one or more products from the product database with the second user based on the personality trait information of the user profile of the second user; and
displaying to the first user the one or more products from the product database correlated to the second user.

13. The method of claim 12, further comprising receiving information from a user and analyzing the information from the user to identify personality trait information of the user and adding the personality trait information of the user to a user profile of the user.

14. The method of claim 12, wherein the personality trait information correlated to a product in the product database comprises personality trait information of other users that have used the product.

15. The method of claim 12, further comprising:
analyzing product data of a product to be added to the product database to determine personality trait information associated with the product data;
analyzing information about users of the product to extract personality trait information from the information about the users of the product;
wherein correlating one or more products from the product database with the second user further comprises correlating the personality trait information of the users of the product with the product and/or correlating personality trait information from the product data with the product; and
inserting product information of the product and associated personality trait information in an entry in the product database.

16. The method of claim 15, further comprising:
searching websites for potential products to be added to the product database and inputting the potential products for analyzing product data of a product to be added to the product database;
finding reviews of the product, wherein analyzing product data of a product to be added to the product database comprises using the reviews to extract personality trait information about users of the product; and/or
locating social media information about the users of the product, wherein analyzing information about users of the product to extract personality trait information comprises extracting personality trait information of the users of the product from the social media information.

17. The method of claim 12, wherein each product entry of the product database comprises a weighting factor for each personality trait of the personality trait information correlated to the product entry and wherein correlating one or more products from the product database with the second user further comprises using a machine learning algorithm configured to update the weighting factors based on personality trait information of users of the products in the product database and/or reviews from users of the product.

18. The method of claim 12, further comprising soliciting a review from the second user after the second user has received a gift selected by the first user, wherein correlating one or more products from the product database with the second user comprises using information from the review in correlating the selected gift with another user.

19. The method of claim 12, wherein a user profile of the second user in the user profile database comprises at least one event associated with the second user and further comprising sending a message to the first user prior to the event, the message comprising a reminder of the event of the second user and/or the display of the one or more products from the product database correlated to the second user.

20. A program product comprising a non-transitory computer readable storage medium storing code, the code being configured to be executable by a processor to perform operations comprising:
creating a user profile database comprising a plurality of user profiles, each user profile of a user comprising user data of the user correlated with personality trait information of the user;
creating a product database comprising product entries of products, each product entry comprising personality trait information correlated to the product;
receiving from a first user a request to recommend a gift to a second user, the second user having a user profile in the user profile database;
correlating one or more products from the product database with the second user based on the personality trait information of the user profile of the second user; and
displaying to the first user the one or more products from the product database correlated to the second user.
